(19) United States
(12) Patent Application Publication
(10) Pub. No.: US 2003/0209684 A1
(43) Pub. Date: Nov. 13, 2003

(54) Diaphragm valve housing for a sanitary container

(76) Inventor: Peter Lin, Warminster, PA (US)

Correspondence Address: Eric A. LaMorte, P.O. Box 434, Yardley, PA, 19067-8434, US

(21) Appl. No.: 10/141,192

(22) Filed: May 9, 2002

(51) Int. Cl. F16K 1/00

(52) U.S. Cl. 251/331

(57) ABSTRACT

A valve assembly for a sanitary container that is used to isolate the contents of the sanitary container. The valve assembly has a valve housing that is machined from a solid piece of stainless steel. A flange radially extends from the bottom of the valve housing, thereby enabling the valve housing to be clamped to the flanged access port of a sanitary container. The valve housing forms part of two separate diaphragm valves. The diaphragm valves control flow through the valve housing along two separate and isolated pathways. Additionally, a conduit is formed vertically through the valve housing. The conduit is unobstructed and enables materials to be passed through the housing of the valve mechanism unabated. The design of the valve assembly prevents the valve assembly from harboring contaminants and enables the valve assembly to be sanitized using a traditional autoclave.

### BACKGROUND OF THE INVENTION

1. Field of the Invention

The present invention relates to the structure of diaphragm valves and the housings of diaphragm valves. More particularly, the present invention relates to diaphragm valves that are used in association with sanitary containers.

2. Description of the Prior Art

In the manufacture and processing of pharmaceutical products, dairy products and other materials that require a sanitary processing environment, it is common for materials to be stored and transported in sanitary containers. Such sanitary containers are typically made of stainless steel. Such sanitary stainless steel containers are manufactured by Eagle Stainless Container, Inc., of Ivyland, Pa. The use of stainless steel is preferred because it enables the containers to be cleaned and sanitized in an autoclave or other harsh washing environment after they have been used. The stainless steel containers can therefore repeatedly be made sterile and can be used over and over again.

Since stainless steel sanitary containers are often used to house sterile materials or bioreactive materials, such sanitary containers typically do not contain threaded closures. Threaded closures provide confined areas between threads that may harbor contaminants or bioreactive material. Due to the physical shape of the threads, it is very difficult to properly clean threads to the sanitary standards needed. It is for this reason that threaded closures are generally not used. Rather, flanged caps are used, wherein the flanged caps are attached with external clamps.

Many stainless steel sanitary containers are manufactured with access ports that terminate with a flanged connection. The flanged connection is a circular flange that radially extends from the neck of the access port. The access port can therefore be connected to a pipe with a similar flanged connection or a cap that contains the proper sized flanged connection. To join any two flanged connections together, the two flanges are placed in abutment so that the openings in the center of each of the flanges align. An O-ring or other gasket is placed between the two flanges. The flanges are then clamped together in a manner that compresses the O-ring and prevents the flanges from falling out of alignment.

In the prior art, there are many different types of clamping mechanisms that have been used to join together flanged connections. Typically, the clamps that have been used are annular in shape. Hinges are disposed along the annular structure to enable the annular structure to open. The clamps are opened and then closed over the span of the two adjoining flanges. The-presence of the clamping device biases the adjoining flanges together and prevents the adjoining flanges from moving out of their aligned positions.

In many industrial and laboratory applications it is desirable to control the flow of material into and/or out of a stainless steel sanitary container. To do this, control valves are typically used to control various flows. However, there are many problems associated with connecting a traditional valve to a stainless steel sanitary container. First, valves typically are not manufactured with pipe flanges that allow the valve to be coupled to the access port of a sanitary container. As such, a valve must first be fitted with a proper flange, prior to its use. Second, valves are mechanical devices that have working parts. The structure of a traditional valve typically includes many threaded areas as well as packing material around the control handle of the valve. Such threaded regions and packing material cannot be reliably cleaned using standard autoclaving protocols. As a result, traditional valves must be removed and replaced each time the system is cleaned. This is a highly labor intensive and expensive maintenance task.

In the prior art, valve housings have been made for various applications that reduce the area in which contamination may accumulate. Such prior art valves are exemplified by U.S. Pat. No. 6,223,435 to Stavrakis, entitled One-Piece Tipless Valve Housing, which discloses a valve housing for a filling machine. However, such prior art valves still contain working internal components and confined areas that cannot be easily sanitized.

Another problem associated with attaching a traditional valve to the access port of a sanitary stainless steel container is that many sanitary containers only have a single access port. Accordingly, if a valve blocks the only access port, all flows into and out of the container must be directed through the structure of the valve. This prevents multiple flows of material both into and out of the container from occurring simultaneously.

A need therefore exists for a valve design that is specifically designed for use on a sanitary container and eliminates the stated disadvantages of prior art valves. This need is met by the present invention as described and claimed below.

### SUMMARY OF THE INVENTION

The present invention is a valve assembly for a sanitary container that is used to isolate the contents of the sanitary container. The valve assembly has a valve housing that is machined from a solid piece of stainless steel. A flange radially extends from the bottom of the valve housing, thereby enabling the valve housing to be clamped to the flanged access port of a sanitary container. The valve housing forms part of two separate diaphragm valves. The diaphragm valves control flow through the valve housing along two separate and isolated pathways. Additionally, a conduit is formed vertically through the valve housing. The conduit is unobstructed and enables materials to be passed through the housing of the valve mechanism unabated. The design of the valve assembly prevents the valve assembly from harboring contaminants and enables the valve assembly to be sanitized using a traditional autoclave.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a perspective view of an embodiment of the present invention valve assembly shown in conjunction with the flanged access port of a sanitary container;

FIG. 2 is a bottom view of the embodiment of the valve assembly shown in FIG. 1; and

FIG. 3 is a selectively exploded perspective view of the valve assembly shown in FIG. 1.

### DETAILED DESCRIPTION OF THE INVENTION

Although the present invention valve assembly can be used to terminate any access port having a pipe flange, such as a supply pipe, shipping container or the like, the present invention valve assembly is especially well suited for terminating a sanitary container. As such, the embodiment of the valve assembly shown is described in conjunction with the flanged access port of a sanitary container in order to set forth the best mode of use contemplated for the invention.

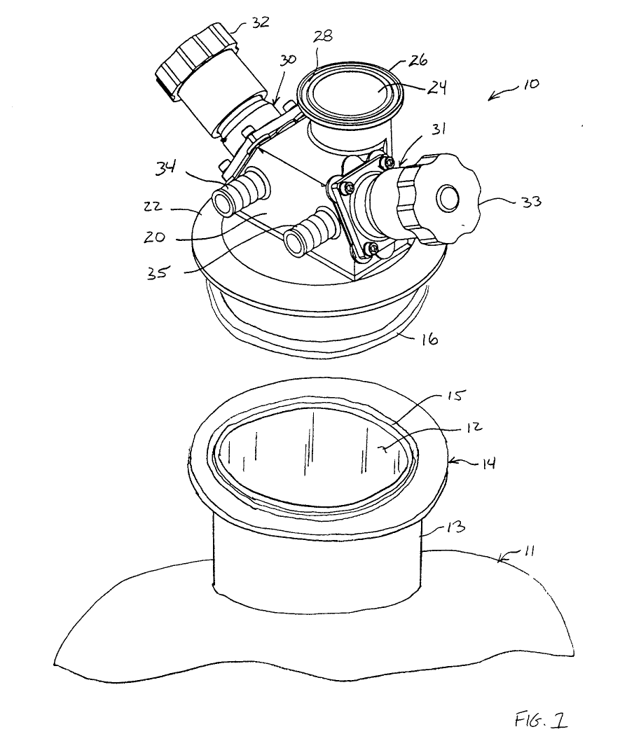

Referring to FIG. 1, an exemplary embodiment of a valve assembly 10 is shown in conjunction with the flanged access port 12 of a sanitary container 11. The access port 12 of the sanitary container 11 includes a tubular neck 13. A circular flange 14 radially extends from the top of the tubular neck 13. A groove 15 is formed on the top face of the circular flange 14. The groove 15 is sized to receive an O-ring 16.

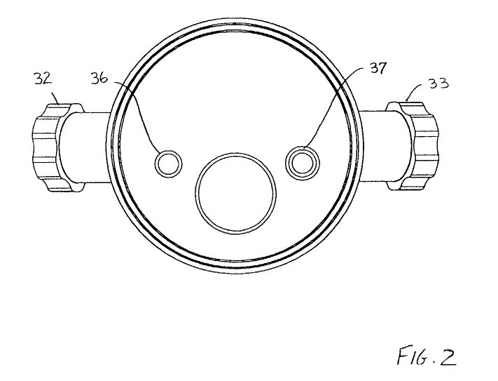

The valve assembly 10 includes a valve housing 20. A circular flange 22 radially extends from the base of the valve housing 20. The circular flange 22 is sized to match the circular flange 14 on the sanitary container 11. On the bottom surface of the flange 22 is a groove 25 (FIG. 2) that accepts the O-ring 16. As such, it will be understood that when the flange 22 at the base of the valve housing 20 is clamped to the circular flange 14 of the sanitary container 11, the O-ring 16 creates a seal between sanitary container 11 and the valve housing 20. Consequently, all flow of materials into and out of the sanitary container 11 must pass through the valve assembly 10.

A large conduit 24 extends vertically completely through the valve housing 20. Consequently, even after the valve housing 20 is clamped to the sanitary container 11, access to the interior of the sanitary container 11 is possible through the large conduit 24. The diameter of the large conduit 24 is between ¼ and 1/2 the diameter of the access port 12 of the sanitary container 11. As such, fluids can be readily poured into the sanitary container 11 or out of the sanitary container 11 through the large conduit 24.

A flange 26 radially extends from the top of the large conduit 24. An O-ring groove 28 is formed in the top of the flange 26. As such, it will be understood that the large conduit 24 can be attached to supply pipes, drain pipes or any other flanged object using a smaller pipe clamp and O-ring (not shown).

The valve assembly contains two diaphragm valves 30, 31. Although the diaphragm valves 30, 31 share the structure of a common valve housing 20, each diaphragm valve 30, 31 is independent and is functionally isolated from the other. Each of the diaphragm valves 30, 31 is controlled by a separate control knob 32, 33 that is bolted to the valve housing 20.

Two nipple connectors 34, 35 extend horizontally from the valve housing 20. The flow of material into or out of each of the nipple connectors 34, 35 is directly controlled by the closest control knob 32, 33. Consequently, the control knob 32 on the observed left of the valve assembly 10 controls the flow of material through the nipple connector 34 on the observed left of the valve assembly 10. Similarly, the control knob 33 on the observed right controls flow through the nipple connector 35 on the observed right.

Referring to FIG. 2, it can be seen that there are two small ports 36, 37 on the bottom of the valve housing 20, on either side of the large conduit 24. The port 36 on the observed left leads to the nipple connector 34 (FIG. 1) on the left side of the valve housing 20. Flow from the left nipple connector 34 (FIG. 1) to the left access port 36 is controlled by the left control knob 32. Similarly, the port 37 on the observed right leads to the nipple connector 35 (FIG. 1) on the right side of the valve housing 20. Flow from the right nipple connector 35 (FIG. 1) to the right access port 37 is controlled by the right control knob 33.

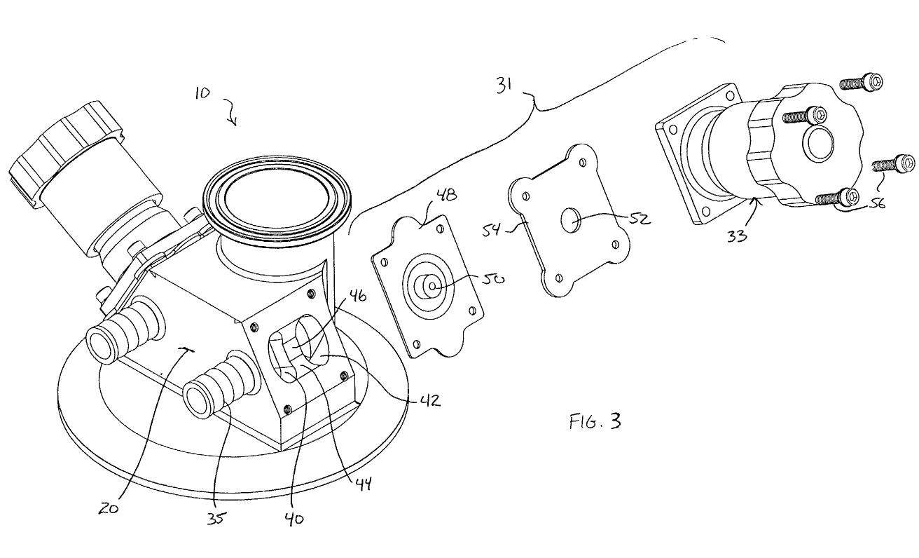

Referring to FIG. 3, the structure of the diaphragm valves 30, 31 embodied by the valve assembly 10 are illustrated. Although the diaphragm valve 31 on only one side of the valve assembly is shown in an exploded fashion, it should be understood that the structure of the diaphragm valve 30 on the other side of the valve assembly 10 is the same. From FIG. 3, it can be seen that two chambers 40, 42 are formed in each side of the valve housing 20. The front chamber 40 leads to the nipple connector 35. The rear chamber 42 leads to the port 37 (FIG. 2) on the bottom of the valve housing 20. A dividing wall 44 separates the front chamber 40 and the rear chamber 42. A depressed contact surface 46 is present on the outwardly facing edge of the dividing wall 44.

An elastomeric diaphragm 48 is placed over the exposed sections of the front chamber 40 and rear chamber 42. When the diaphragm 48 is pressed against the contact surface 46 on the dividing wall 44, a seal is made against the dividing wall 44 and the front chamber 40 is isolated from the rear chamber 42. However, when the diaphragm 48 is not biased against the contact surface 46 of the dividing wall 44, material can flow between the contact surface 46 and the diaphragm 48 from the front chamber 40 to the rear chamber 42.

The diaphragm 48 has a protrusion 50 extending from its center. The protrusion 50 extends through an aperture 52 in a rigid support plate 54. The control knob 33 selectively applies a bias to the protrusion 50 as it is turned. The control knob 33, support plate 54 and diaphragm 48 are mounted to the valve housing 20 with bolts 56. However, only the diaphragm 48 is ever in contact with the material that flows through the valve housing 20. Consequently, even though the control knob 33 and the bolts 56 contain threaded components that can harbor contaminants, the control knob 33 and the bolts 56 are never exposed to those contaminants and therefore do not pose a contamination problem.

To clean the valve assembly 10, the bolts 56 holding the control knobs 32, 33 in place are undone and the control knobs 32, 33 are removed. The control knobs 32, 33 are free from contaminants because the control knobs 32, 33 have been completely isolated from the material flowing through the valve assembly 10. After the control knobs 32, 33 are removed, the diaphragms 48 can be removed and discarded. Once each diaphragm 48 is removed, the two chambers 40, 42 under that diaphragm 48 are fully exposed. The valve housing 20 is then ready to be cleaned using traditional autoclaving procedures. Since there are no accessible regions in the valve housing 20, the valve housing 20 meets sterilization requirements using traditional autoclaving cleaning protocols.

Referring back now to FIG. 1, the valve housing 20, including the nipple connectors 34, 35, the flange 22 and the large conduit 24, is preferably machined from a solid block of stainless steel. Accordingly, there are no welds or abutment gaps between the nipple connectors 34, 35, the flange 22, the large conduit 24 and the remainder of the valve housing 20 that can harbor contaminants during an autoclave cleaning procedure.

The valve assembly provides three separate ways to access the sanitary vessel. The large conduit enables direct access to the interior of the sanitary vessel without valve control. The two nipple connectors 34, 35 provide access to the interior of the sanitary container with valve control. Accordingly, material can be added to and/or removed from a sanitary vessel using three separate pathways.

It will be understood that the various figures described above illustrate only one preferred embodiment of the present invention. A person skilled in the art can therefore make numerous alterations and modifications to the shown embodiment utilizing functionally equivalent components to those shown and described. For example, the angles at which the nipple connectors and the control knobs extend from the valve housing can be altered. Furthermore, the external configuration of the nipple connectors and the control knobs can also be selectively changed. All such modifications are intended to be included within the scope of the present invention as defined by the appended claims.

What is claimed is:

1. A valve assembly, comprising:
a valve housing having a bottom, a top and at least one side surface, said valve housing containing a first chamber and a second chamber, wherein both said first chamber and said second chamber intersect and are exposed along a first side surface;
a flange radially extending from said valve housing;
a first port extending into said valve housing, wherein said first port intersects said first chamber;
a second port extending into said valve housing, wherein said second port intersects said second chamber;
a diaphragm mounted over said first side surface, wherein said diaphragm regulates flow between said first chamber and said second chamber as a function of diaphragm deflection; and
a manual controller for selectively controlling diaphragm deflection in said diaphragm.

2. The assembly according to claim 1, further including a conduit extending vertically through said valve housing unobstructed, wherein said conduit is isolated from said first chamber and said second chamber.

3. The valve assembly according to claim 1, further including a third chamber and a fourth chamber disposed within said valve housing, wherein said third chamber and said fourth chamber intersect and are exposed along a second side surface of said valve housing.

4. The valve assembly according to claim 3, further including:
a third port extending into said valve housing, wherein said third port intersects said third chamber;
a fourth port extending into said valve housing, wherein said fourth port intersects said fourth chamber;
a second diaphragm mounted over said second side surface, wherein said diaphragm regulates flow between said third chamber and said fourth chamber as a function of diaphragm deflection; and
a second manual controller for selectively controlling diaphragm deflection in said second diaphragm.

5. A valve assembly, comprising:
a valve housing having a top, a bottom and at least one side surface, wherein said valve housing defines a conduit that extends unobstructed through said valve housing from said top to said bottom;
a flange radially extending from said valve housing proximate said bottom;
a first port on a side surface of said valve housing;
a second port on said bottom of said valve housing;
a manual control mechanism for selectively controlling flow between said first port and said second port.

6. The assembly according to claim 5, wherein said conduit is terminated at one end with a flange connection.

7. The assembly according to claim 5, wherein said valve housing and said flange are machined from a single piece of stainless steel.

8. The assembly according to claim 5, wherein said manual control mechanism is a diaphragm valve.

9. The assembly according to claim 5, wherein said valve housing defines a first chamber and a second chamber, wherein said first chamber and said second chamber both intersect and are exposed along a first side surface of said valve housing.

10. The assembly according to claim 9, wherein said first port intersects said first chamber and said second port intersects said second chamber.

11. The assembly according to claim 10, wherein said manual control mechanism includes a diaphragm that regulates flow between said first chamber and said second chamber as a function of diaphragm deflection and a control knob for selectively controlling the diaphragm deflection of the diaphragm.

12. The valve assembly according to claim 9, further including a third chamber and a fourth chamber disposed within said valve housing, wherein said third chamber and said fourth chamber intersect and are exposed along a second side surface of said valve housing.

13. The valve assembly according to claim 12, further including:
a third port extending into said valve housing, wherein said third port intersects said third chamber;
a fourth port extending into said valve housing, wherein said fourth port intersects said fourth chamber;
a second diaphragm mounted over said second side surface, wherein said diaphragm regulates flow between said third chamber and said fourth chamber as a function of diaphragm deflection; and
a second manual controller for selectively controlling diaphragm deflection in said second diaphragm.

14. A valve assembly, comprising:
a valve housing having a top, a bottom and side surfaces;
a first port and a second port disposed on at least one side surface of said valve housing;
a third port and a fourth port disposed on said bottom of said valve housing;
a first valve control extending from said valve housing, wherein said first valve control selectively controls flow between said first port and said third port;
a second valve control extending from said valve housing, wherein said second valve control selectively controls flow between said second port and said fourth port; and
a flange radially extending from said valve housing.

15. The assembly according to claim 14, further including a conduit extending vertically through said valve housing unobstructed.
